(19) United States
(12) Patent Application Publication
(10) Pub. No.: US 2022/0012829 A1
(43) Pub. Date: Jan. 13, 2022

(54) Automated Home Recommendation Engine

(71) Applicant: Wells Fargo Bank, N.A., San Francisco, CA (US)

(72) Inventors: Ricky Alan Brame, Des Moines, IA (US); Paul Ferguson, Adel, IA (US); Scott Curtis Grengs, Lakeville, MN (US); Dan R. Grizzle, Clive, IA (US); Suhas Dattatreya Sankolli, Charlotte, NC (US)

(21) Appl. No.: 15/824,564

(22) Filed: Nov. 28, 2017

(51) Int. Cl. G06Q 50/16; G06Q 40/02; G06Q 30/02; H04L 12/28; H04L 29/08

(52) U.S. Cl. CPC G06Q 50/167; G06Q 40/025; G06Q 30/0201; H04L 12/2825; H04L 67/22; H04L 67/306; G06Q 30/0206

(57) ABSTRACT

A method implemented on an electronic computing device includes selecting a next home for purchase. Data is obtained from a plurality of sensor devices in a current home and from a plurality of data points external to the current home. The data from the sensor devices and the data points external to the current home are used to automatically select one or more aspects for the next home. One or more next homes to purchase that include one or more of the aspects are automatically identified. One of the identified one or more next homes are automatically recommended to purchase. When to purchase the identified next home is automatically recommended.

### BACKGROUND

Individuals typically purchase homes that they consider optimal for their personal circumstances at a time when they purchase the home. However, personal circumstances can change for individuals. Events such as new family members, a promotion, a change of jobs or other events may cause the individuals to think of purchasing a different or better home.

When individuals are in the market for new or different homes, the individuals may consider many factors before deciding which new or different home to purchase. The individuals also typically need to consider factors regarding selling their current home before they can purchase the new or different home.

### SUMMARY

Embodiments of the disclosure are directed to a method implemented on an electronic computing device for selecting a next home for purchase, the method comprising: obtaining data from a plurality of sensor devices in a current home and from a plurality of data points external to the current home; using the data from the sensor devices and the data points external to the current home, automatically selecting one or more aspects for the next home; automatically identifying one or more next homes to purchase that include one or more of the aspects; automatically recommending one of the identified one or more next homes to purchase; and automatically indicating when to purchase the identified next home.

In another aspect, a method implemented on an electronic computing device for selecting a next home for purchase comprises: obtaining user preferences for the next home; identifying traffic patterns in a current home of the user; based on the user preferences and the traffic patterns, identifying the next home for purchase; and automatically recommending when to initiate a process to purchase the next home that is identified.

In yet another aspect, an electronic computing device comprises: a processing unit; and system memory, the system memory including instructions which, when executed by the processor, cause the electronic computing device to: obtain data regarding traffic patterns in a current home; obtain data from one or more sensor devices in the current home regarding maintenance needs in the current home; obtain data regarding user preferences for a next home; obtain data regarding commute time for individuals in the current home; use the data regarding the traffic patterns, the maintenance needs, the user preferences and the commute time to automatically select one or more aspects for the next home; automatically identify one or more homes that satisfy the one or more aspects for the next home; automatically recommend at least one of the identified homes for purchase; obtain data regarding market conditions for buying and selling a home, the market conditions including a current mortgage interest rate and information regarding an average number of days for selling homes similar to the current home; and use the market conditions to automatically indicate when to purchase the next home.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports an automated home recommendation engine.

FIG. 2 shows example modules of the home recommendation engine of FIG. 1.

FIG. 3 shows an example user interface screen that can be used with the home recommendation engine of FIG. 1.

FIG. 4 shows another example user interface screen that can be used with the home recommendation engine of FIG. 1.

FIG. 5 shows yet another example user interface screen that can be used with the home recommendation engine of FIG. 1.

FIG. 6 shows yet another example user interface screen that can be used with the home recommendation engine of FIG. 1.

FIG. 7 shows yet another example user interface screen that can be used with the home recommendation engine of FIG. 1.

FIG. 8 shows an example method for automatically recommending a home for purchase.

FIG. 9 shows an example operation of the method of FIG. 8.

FIG. 10 shows example physical components of the server computing device of the system of FIG. 1.

### DETAILED DESCRIPTION

The present disclosure is directed to systems and methods for an automated home recommendation system that can automatically recommend to an owner of a current home one or more next homes for the owner to purchase.

In some examples, recommendations can be based on both active factors, such as preferences made known by the owner of the home, and passive factors, such as passive detection of conditions in the home such as traffic patterns and noise. The systems and methods can also provide for automatically recommending when to sell the current home. As used in this disclosure, a home refers to an abode that is owned by an individual, including a stand-alone house, a townhouse, a condominium or any other residence that is owned by the individual.

Active factors can include preferences of the home owner for the next home. Preferences can include aspects such as location, style of home, number of rooms, specific types of rooms and whether items such as commuting time and distance, schools, parks, shopping and public transportation are important considerations in selecting the next home. These and other aspects can be entered by the home owner into a digital dashboard, as discussed in detail later herein. Some of the preferences, such as style of home and number and types of rooms can be considered to be internal aspects of the home. Other preferences, such as the importance of commuting time, schools, parks and shopping can be considered to be external aspects of the home. Thus, both internal and external aspects of the home can be considered when identifying a next home.

Passive factors can include aspects such as traffic patterns in the home, noise levels in the home, a condition of operational items in the home such as a furnace, air conditioner and appliances and other aspects. The aspects of the passive factors can be obtained via sensor devices, cameras, and other devices that can be placed throughout the home. For example, sensor devices can be used with items such as the furnace, air conditioner, appliances and other items to monitor operational aspects and a current condition of the items. The sensor devices can also be Internet of Things (IOT) sensors that can include wireless means to communicate sensor data to an electronic computing device. These passive factors can be considered to be internal aspects of the home. Other passive factors, such as a passive determination of commuting time to work, can be considered to be external aspects of the home. The determination of commuting time can be passively measured via global positioning system (GPS) software on a smartphone or in a vehicle of the home owner and members of the home owner's family who commute to work.

The active and passive factors can be used by the systems and methods to search for a next home that would be consistent with the active and passive factors. When one or more potential next homes are found, the identified next homes can be presented to the home owner for consideration.

Many factors can be taken into account by individuals regarding a next home to purchase. Factors can include such things as size of a family, age of children, income of the home owner and the spouse of the home owner, job changes, etc. For example, individuals who receive a pay increase or a promotion may be able to afford a larger or better home. Individuals who have added family members may feel that their current home is now too small and that they need a larger home. Individuals whose children may have gone off to college or have otherwise left home may feel a need to downsize. Individuals who have changed jobs may want a home that is closer to their new job. Individuals who may feel that their neighborhood has become unsafe may want to move to a safer neighborhood. Other factors can be taken into consideration regarding the next home to purchase.

For many individuals, purchasing a next home requires selling a current home in order to obtain enough funds for a down-payment and other items associated with the next home. The systems and methods can automatically evaluate market conditions for a sale of a current home and present recommendations for selling the current home. Example market conditions can include a number and type of homes currently for sale on the market, expected prices for homes similar to the current home, current interest rates for home mortgages and an average number of days for selling a home. Other market conditions can be considered.

The automated home recommendation system can be implemented by an organization such as a realty company. The realty company can receive passive data from home sensor devices, can use passive and active data to identify types of homes the home owner may be interested in, can conduct searches for identified types of homes and can facilitate the purchase of a new home and the sale of the current home for the customer. Other types of organizations can be used. For example the automated home recommendation system can be implemented by a financial institution for which the home owner has one or more financial accounts. When the automated home recommendation system is implemented by an organization such as a financial institution that may not have a capability to identify homes for sale, the organization can use third party sources to obtain this information.

In addition to identifying next homes available for purchase and evaluating current market conditions, the systems and methods can determine an optimal time for both selling the current home and purchasing and moving to the next home. A recommendation regarding the optimal time can be presented to the home owner via the digital dashboard.

The systems and methods disclosed herein are directed to a computer technology that can automatically recommend a next home for purchase, automatically recommend when to purchase the next home and automatically recommend an optimal time to sell a current home. The systems and methods can base the recommendations on aspects of active and passive data regarding the current home and the next home. The passive data can be automatically gathered via motion detectors, appliance and other system sensors, by GPS software on smartphones or vehicles of the home owner and members of the home owner's family and from data from third party sources. The third party sources can include realty companies which can provide home search information, financial institutions which can provide information regarding current interest rates and home sale data and other third party sources, such as third party sources that can provide information regarding crime and noise in neighborhoods where identified homes for purchase are located.

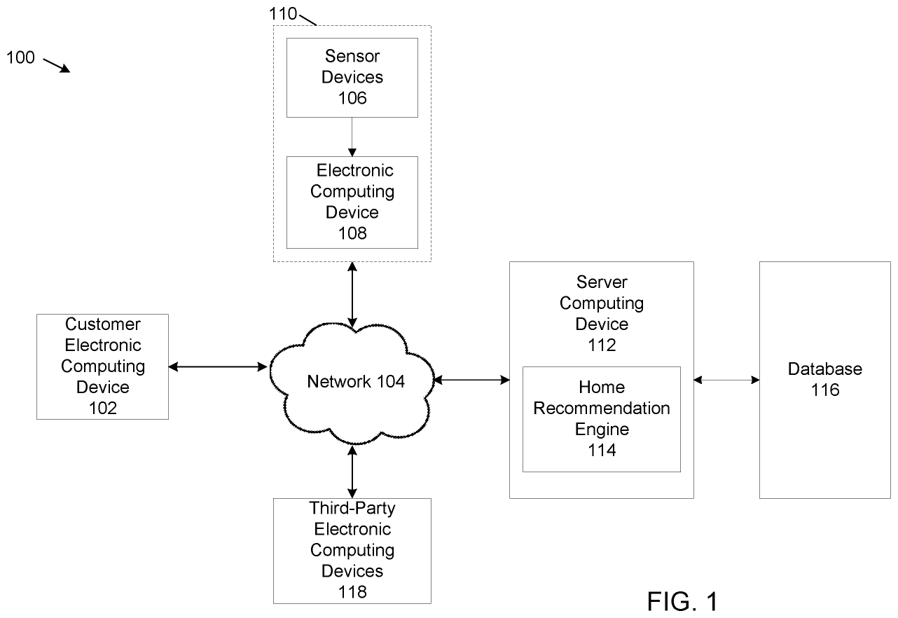

FIG. 1 shows an example system 100 that can support an automated home recommendation engine. System 100 includes customer electronic computing device 102, network 104, home 110, server computing device 112, database 116 and third-party electronic computing devices 118. Home 110 includes sensor devices 106 and electronic computing device 108. Server computing device 112 includes home recommendation engine 114. More, fewer or different components can be used.

The example customer electronic computing device 102 is an electronic computing device of an individual who is a customer of an organization that provides the automated home recommendation engine 114. For system 100, the customer is an owner of the home 110. The electronic computing device can be one of a desktop computer, a laptop computer of a mobile computing device such as a tablet computer or a smartphone. More than one customer electronic computing device 102 can be used.

The example network 104 is a computer network such as the Internet. Customer electronic computing device 102, electronic computing device 108 and third-party electronic computing devices 118 can communicate with server computing device 112 using network 104.

The example server computing device 112 is a server computing device of the organization, for example a real estate company, that can implement the home recommendation engine 114. More than one server computing device 112 can be used.

The example home recommendation engine 114 uses active and passive inputs to recommend a next home to purchase to the home owner. Active inputs can be provided via personal data regarding the home owner and via personal preferences for a next home provided by the home owner. The personal data, including such items as name, contact information, family data, employment data and similar type of information can be provided to the organization via personal contact with an organization representative, by telephone, by the Internet or by mail. The personal preferences regarding the next home can be entered by the home owner or a family member of the home owner via a digital dashboard that can be rendered on customer electronic computing device 102.

Passive inputs can per provided via sensor devices and application software in the home and in vehicles of the home owner. The sensor devices in the home can provide operational data regarding items in the home such as a furnace, air conditioner and appliances. The application software, for example GPS software that can be embedded in the vehicle or part of a software application on a smartphone, can provide a driving history for each vehicle. The driving history can help determine how far the home owner and family members live from work and a driving distance and time to work. When a plurality of family members have jobs, a driving history can be obtained for each family member. The GPS software (for example on a smartphone) can also determine a commute time for family members using public transportation to commute to work.

Home recommendation engine 114 can also help conduct a search for the next home based on the active and passive inputs, and determine market conditions for a purchase of the next home and sale and the current home. Home recommendation engine 114 can also propose a recommendation of a specific next home to purchase, when to purchase the next home and when to sell the current home.

The example database 116 is a database associated with the organization. Information regarding active and passive inputs from the home owner and the current home can be stored in database 116. Database 116 can be distributed over a plurality of databases. The home recommendation engine 114 can be programmed to query (e.g. using SQL) database 116 to obtain home search and other information. Various active and passive home information can be stored in and retrieved from database 116.

An example schema of inventory information stored in database is shown below:
Customer ID—a set or letters, numbers or other symbols that uniquely identifies a customer;
Customer Personal Data Pointer—a pointer to a record of personal data for the customer and family members of the customer;
Next Home Preferences Pointer—a pointer to customer preferences for a next home;
Traffic Patterns Data Pointer—a pointer to data regarding traffic patterns in rooms of the customer's current home;
Maintenance Information Pointer—a pointer to maintenance information for appliances and other items in the current home;
Customer Commute Time—an average commute time for the customer between the current home and an employment location for the customer;
Spouse Commute Time—an average commute time for the customer's spouse between the current home and an employment location for the customer's spouse;
Current Market Value—a current market value for the current home;
Identified Homes Pointer—a pointer to a list of identified homes that corresponds to the customer's preferences for a next home
Recommendation Pointer—a pointer to a recommendation made to the customer regarding a next home to purchase and/or a sale of a current home

The above schema permits the database to be queried for data such traffic patterns in the current home, maintenance history of items in the current home and identified homes for purchase.

For example, the following messaging format can be used between the server computing device 112 and the database 116 to obtain maintenance history for items in the current home.

| | | |
|---|---|---|
| Customer ID | Date Range | Maintenance History |

The database 116 can use the following messaging format in responding to such a request.

| | | | | |
|---|---|---|---|---|
| Customer ID | Item | Date of first | Description of | . . . |
| | | maintenance | first maintenance | |
| | | service | service | |

The response message can include many additional fields depending on how many maintenance service calls were made for the item. Similar message formats can be used for other fields.

The example third-party electronic computing devices 120 are electronic computing devices, for example server computing devices and databases from a variety of sources that help facilitate obtaining information regarding the home recommendation process. For example, one or more of the server computing devices and databases can be realty organizations that can provide information regarding homes for sale that meet criteria for the next home. Other server computers and databases can provide information regarding current market conditions for buying and selling homes. Still other server computing devices and databases, for example from a financial institution at which the home owner has one or more financial accounts, can provide personal financial information regarding the home owner and family members of the home owner. Still other server computing device and databases can provide other types of information.

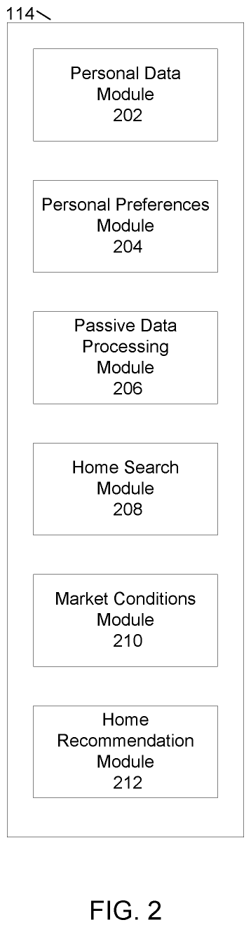

FIG. 2 shows example modules of home recommendation engine 114. The example home recommendation engine 114 includes a personal data module 202, a personal preferences module 204, a passive data processing module 206, a home search module 208, a market conditions module 210 and a home recommendation module 212. More, fewer or different modules are possible.

The example personal data module 202 obtains, processes and initiates storage of personal information regarding the home owner and the family of the home owner. The personal information can include items such as name, contact information, family data, employment data and similar types of information. Personal data module 202 can initiate storage of the personal information, typically in database 116. The personal data can be obtained from a plurality of sources including the home owner and the home owner's family and from one or more third-party sources (via third-party electronic computing devices 118 associated with the third-party sources or via contacts with employees of the third-party sources). The third-party sources can include financial institutions, employers of the home owner and family members of the home owner, realty companies, government organizations and other third-party sources.

The example personal preferences module 204 processes personal preferences regarding wanted characteristics of a next home that are provided by the home owner or by family members of the home owner. The preferences can include such items as a price range for a new home, a location, a number of rooms, etc. The preferences can be entered via digital dashboard rendered on customer electronic computing device 102, as discussed in more detail later herein.

The example passive data processing module 206, processes data received from sensor devices, cameras, GPS devices or any other devices that can obtain passive data regarding the home, the home owner and family members of the home owner. The sensor devices can provide operational data regarding items in the home to which the sensor devices are attached or embedded. The sensor devices and cameras can provide data regarding traffic patterns in the home.

For example, the passive data processing module 206 can process data from sensor devices and cameras in the home to determine traffic patterns in the home. Sensor devices can include devices such as motion detectors, pressure sensors, voice sensors, heat sensors and radar-based sensors. Some sensor devices can be added to the home by the home owner, other sensor devices can be proprietary sensor devices that can be built into the home.

Motion sensors, also known as motion detectors, can include light sensors, infrared sensors, microwave sensors and ultrasonic sensors. Light sensors can used focused light, such as laser beams, that can send out a beam of light. For example, light sensors can be placed to send out a beam of light across an entrance point of a room, such as a doorway. When an individual enters the room and crosses the beam of light, the light sensor can register a change in light level and determine that the individual has entered or left the room. Infrared motion sensors can detect infrared energy emitted from humans in the form of heat. When there is a sudden increase in infrared energy, the infrared sensor can determine the presence of a human. Microwave sensors can detect motion via detecting phase shifts (Doppler shifts) in microwave radiation. A microwave sensor can emit a continuous wave of microwave radiation. Phase shifts in the microwave radiation can be detected due to motion of an individual towards or away from the microwave sensor. Ultrasonic sensors can emit an ultrasonic wave and receive reflections from nearby objects. The ultrasonic sensors can detect motion by detecting a phase shift (Doppler shift) in the reflected wave when an individual moves towards or away from the ultrasonic sensor.

Pressure sensors are devices that can generate a signal as a function of pressure imposed on the pressure sensor. Pressure sensors can be placed at strategic points in the floors of the home and can detect when individuals walk on those points. For example, pressure sensors placed just outside of doorways can detect when an individual enters or leaves a room. In addition, the pressure sensors can be calibrated to detect a weight of an individual. By detecting the weight of the individual and by comparing this weight to known weights of family members, a determination can be made as to which family member triggered the pressure sensor.

Voice sensors can detect human sound waves and can detect the presence of an individual in a room. The voice sensors can also determine from the frequencies of the sound waves whether the individual is male or female and whether the individual is an adult or a child. Some voice sensors can be trained to recognize voice patterns of specific individuals and may be able to identify individuals in a room from their voice patterns. An example of a voice sensor is the Echo from Amazon Corporation.

Heat sensors can measure the heat emitted from an object and can detect an infrared heat signature from the object. Strategically placed heat sensors in a room can detect heat signatures from individuals in the room and can determine when an individual is in the room.

Radar-based sensors are sensors that use the Doppler effect to detect phase shifts in waves caused by motion towards or away from the radar-based sensors. The radar-based sensors can include the microwave and ultrasonic sensors discussed earlier herein to detect motion. The radar-based sensors can also be used to detect physiological characteristics of an individual, such as heartbeat.

Cameras can be used with one or more of the motion sensors described above. For example, sensing of motion by a motion sensor can activate a camera that can obtain more information about the individual who activated the motion sensor. For example, the camera can include a wide enough lens to capture an image of an individual who triggers the motion sensor. The image can be analyzed to identify the individual and to determine whether the individual is entering or leaving a room.

Other devices can also be used to detect the presence of individuals in a room. One example device is Kinect for Xbox from Microsoft Corporation. Kinect can be used to determine motion and can also be used for voice recognition and to detect an individual's heart rate.

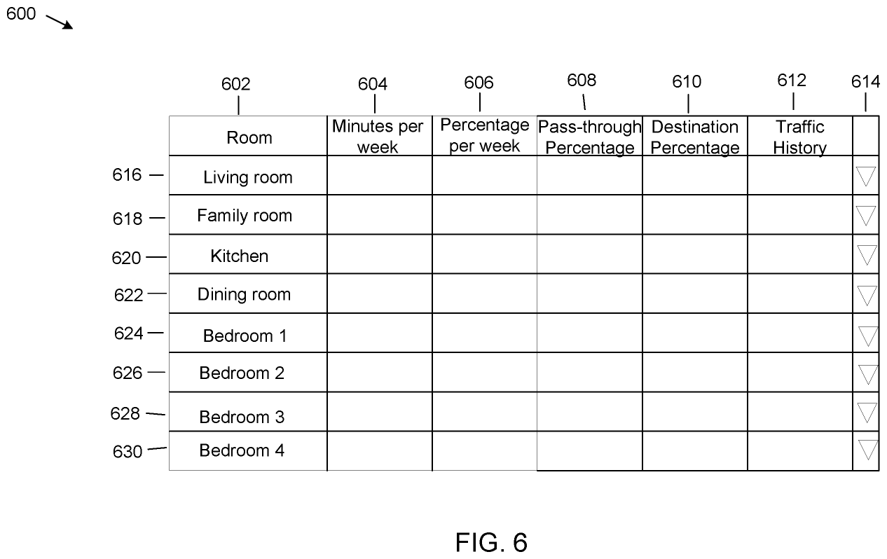

Passive data processing module 206 can analyze data from the motion sensors and other sensor devices described above, herein to determine traffic patterns in the home. Passive data processing module 206 can obtain information regarding a layout of the rooms in the home. The information regarding the layout of the rooms in the home can be obtained from one or more third-party electronic devices 118, for example from a third-party electronic device of a realty company. Passive data processing module 206 can analyze the data from the motion sensors and use information regarding family members to determine an amount of time individuals spend in each room of the home and a traffic flow of individuals from room to room. This data can also be displayed on a user interface, for example user interface 600 of FIG. 6, described later herein.

In one example, existing sensor devices within the home are used. Examples of existing sensor devices within the home can include alarm systems and voice recognition systems such as Amazon Alexa or Google Home.

In another example, proprietary sensor devices are used. The proprietary sensor devices can be installed with the construction of the property and/or added at later date. Examples of proprietary sensor devices can include floor sensors, motion sensors and heat sensors that can be built into specific locations on the property.

In one example, sensor devices are used to provide crude representations of how rooms in a home are used. For example, sensor devices can determine how much time family members spend in each room of the home, as summarized in user interface 600 of FIG. 6.

In another example, the system can be more sophisticated to understand the traffic patterns between rooms. The traffic patterns can be estimated based on usage and based on an analysis of movement of individuals between rooms.

In yet another example, a traffic pattern heat map can display colors representing traffic flow in the home. In an example implementation, heavy traffic flows can be shown using thick lines and bright colors and light traffic flows can be shown using thin lines and dull colors. In another implementation, different colors can be used to represent different usage levels and rooms in the home can be displayed with a color corresponding to the usage level. For example, a bright red color can indicate heavy usage and a light blue color can indicate low usage. Colors indicating various levels of intermediate usage can also be used. A legend can correlate a specific usage percentage with a color.

In other examples, the system can differentiate between the number of people in a room and/or differentiate between individuals—via use of voice or physiological measurements—e.g., Amazon Alexa can determine individuals based upon voice; Doppler could determine physiological measurements (e.g., heart rate, respiratory rate) that differentiate individuals. Pressure plates could determine weight of persons.

The traffic patterns in the home can also be used to define characteristics of a next home for the family. For example, if traffic data indicates that the dining room in the home is used infrequently, for example only a few times a year, home recommendation engine 114 may recommend that the next home does not include a dining room. Similarly, if traffic data indicates that the family spends most of its time in the family room, home recommendation engine 114 may recommend that the next home include a larger family room or a great room. The traffic patterns can also help to determine a floor plan for the next home. For example, if traffic data indicates that family members move most often from between the kitchen and the family room, home recommendation engine 114 may recommend that the kitchen be closer to the family room than in the current home.

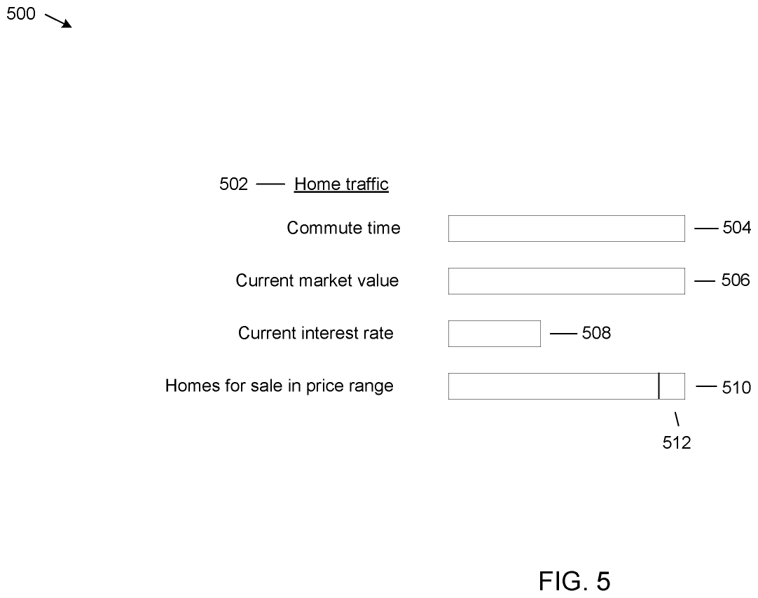

The GPS devices (including smartphones of the home owner and family members of the home owner) can provide a driving history or other commuting history for family members. Each smartphone can include a software application that can provide a geolocation of the smartphone to server computing device 112 on a periodic basis, for example every minute. Passive data processing module 206 can analyze the geolocation data to determine whether the smartphone user is traveling, determine from the geolocation data whether the smartphone user is in a vehicle and create a driving history for the smartphone user. The home search module 208 can make use of the driving history to determine priorities for the next home. See FIG. 5 for more details regarding these examples.

When the organization is a realty company or similar organization that can identify home for sale, the example home search module 208 can conduct a search for a next home for the home owner based on identified priorities for the next home. Home recommendation engine 114 can identify the priorities and present the priorities to the third-party systems based on inputs from personal data module 202, personal preferences module 204 and passive data processing module 206. When the organization does not have capability to identify homes for sale, the home search module 208 can send the identified priorities for the next home to one or more third-party organizations that can identify homes for sale. The third-party organizations can include one or more of third-party electronic computing devices 118.

The example market conditions module 210 can automatically identify market conditions related to purchasing a next home and selling a current home. The market conditions can include one or more of a number of homes currently on the market for sale, the average number of days a home is on the market before sale, a current interest rate for home mortgages and other market conditions. When the organization does not have the capability to identify market conditions, the market conditions module 210 can identify and interface with one or more third-party organizations that can identify the market conditions. The third-party organizations can include one or more of third-party electronic computing devices 118.

The example home recommendation module 212 processes information from one or more of personal data module 202, personal preferences module 204, passive data processing module 206, home search module 208 and market conditions module 210 and determines one or more recommendations to make to the home owner regarding the next home and the current home. The recommendations can comprise a recommendation for a specific home to purchase, a set of homes that satisfy criteria of the home owner, a specific time to purchase a home, a suggested purchase price, a floor plan layout for a home, a recommendation, based on market conditions, regarding when to sell the current home and other recommendations.

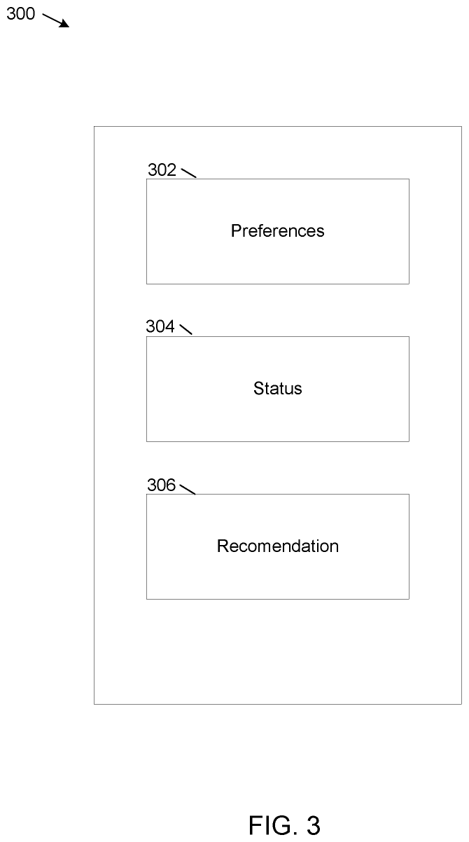

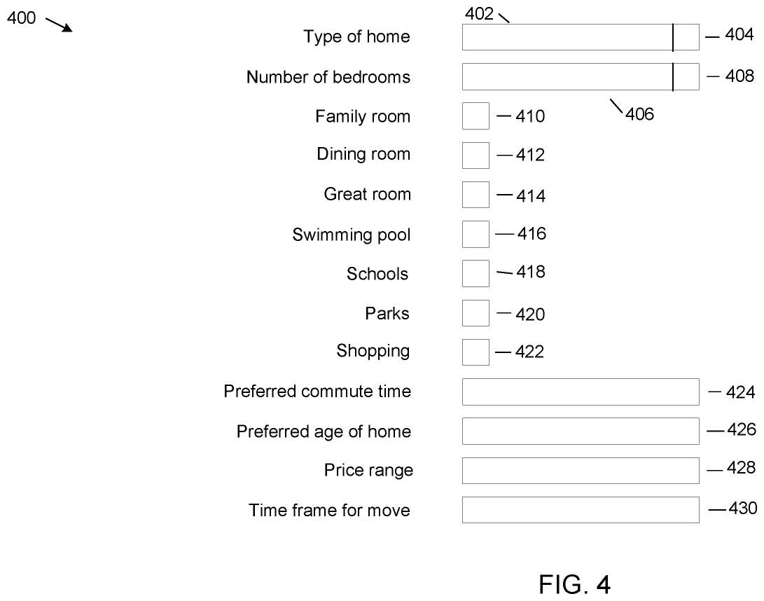

FIG. 3 shows an example user interface screen 300 of a software application that can be used to facilitate a purchase of a next home. User interface screen 300 can be rendered on a display screen of customer electronic computing device 102, typically a mobile device such as a smartphone or tablet computer. User interface screen 300 as well as user interface screens shown in FIGS. 4-7 are part of a digital dashboard that can be rendered on customer computing electronic computing device 102.

User interface screen 300 includes buttons or similar controls for preferences 302, status 304 and recommendation 306. When preferences 302 is selected, a user interface screen is rendered from which the home owner can enter preferences regarding the next home. When status 304 is selected, a user interface screen is rendered from which the home owner can view status information regarding the current home and the next home. When recommendation 306 is selected, a user interface screen is rendered that can present a recommendation for purchasing the next home and selling the current home.

FIG. 4 shows an example user interface screen 400 from which the home owner can enter preferences regarding the next home. User interface screen 400 is activated when the preferences 302 button is selected. User interface screen 400 permits preferences to be entered regarding a type of home, number of bedrooms, type of rooms, schools, parks, shopping, commute time, preferred age of home, price range and time frame to move. More, fewer or different preference items can be included.

The type of home can be selected from combo list box 402. The home owner can use menu control 404 to display different types of homes and then select one type from the types displayed. Example home types can include, colonial, ranch, Cape Cod, row house, townhouse and condominium. Other home types are possible.

The number of bedrooms can be selected from combo list box 406. The home owner can use menu control 408 to display different number of bedrooms, for example one, two, three, four and five and then select one from combo list box 406.

User interface screen 400 includes a series of checkboxes by which the home owner can select various preferences. Checkbox 410 can be checked to select a preference for a family room, check box 412 can be checked to select a preference for a dining room, check box 414 can be checked to select a preference for a great room, checkbox 416 can be checked to select a preference for a swimming pool, checkbox 418 can be checked to select a preference for good schools, checkbox 420 can be checked to select a preference for nearby parks and checkbox 422 can be checked to select a preference for nearby shopping. More, fewer, or different checkboxes are possible.

User interface screen 400 also includes a series of edit boxes 424, 426, 428 and 430. A preferred commute time can be entered into edit box 424. A preferred age of home can be entered into edit box 426. A preferred price range can be entered into edit box 428 and a preferred time frame to move can be entered into edit box 430. More, fewer or different edit boxes are possible.

FIG. 5 shown an example user interface screen 500 from which the home owner can view status information regarding the next home and the current home. User interface screen 500 is activated when the status 304 button is selected. User interface screen 500 displays or activates status information regarding home traffic, commute time, current market value, current interest rate and home for sale in a price range.

User interface screen 500 includes a link for home traffic 502. When the home traffic 502 is selected, information regarding traffic patterns in the home is displayed. The information displayed is discussed in more detail later herein with regard to FIG. 6.

User interface screen 500 includes a display box 504 for commute time. The commute time corresponds to an average time for a commute from the current home to a work location for one or more family members. The commute time can be calculated by monitoring time and distance to work over a period of time for each participating family member and calculating an average commute time. The commute time can be determined from a distance and time of each commute. The distance can be determined via GPS software on a personal device in or in a vehicle of each participating family member. The time can be also be determined via the GPS software as a result of determining a time each vehicle leaves the current home and a time that each vehicle arrives at an employment location. A participating family member is one who is employed and who has registered a personal GPS device, for example on a smartphone, with server computing device 112. Registration can occur using a software application for home recommendation engine 114 that can be access via customer electronic computing device 102.

User interface screen 500 also includes a display box 506 for a current market value of the current home, a display box 508 for a current mortgage interest rate and a list box 510 showing current homes for sale in a price range acceptable to the home owner.

FIG. 6 shows an example user interface screen 600 that shows traffic patterns in the home. User interface screen is displayed when the home traffic 502 button is selected.

User interface screen 600 includes columns for room 602, minutes per week 604, percentage per week 606, pass-through percentage 608, destination percentage 610 and traffic history 612. User interface screen 600 also includes rows for living room 616, family room 618, kitchen 620, dining room 622, bedroom 1 624, bedroom 2 626, bedroom 3 628 and bedroom 4 630. More, fewer or different rows and columns are possible.

User interface screen 600 can display a number of minutes per week in which family members spend in each room of the home and a percentage of time in which each room is used. The percentage for each room can be calculated by determining a sum of the number of minutes spent in each room and dividing the time spent in each respective room by the sum. A determination of how much time is spent in each room can be obtained from one or more of motion detectors, cameras and other sensor devices in each room.

User interface screen 600 can also provide an analysis of how individuals move throughout the home. Each room can include a pass-through percentage 608, a destination percentage 610 and a traffic history 612. The pass-through percentage 608 can represent a percentage of the minutes per week for the room in which an individual passes through the room in the process of proceeding to another room in the home. In an example implementation, the individual can be considered to be passing through the room when the individual stays in the room for less than one minute. The destination percentage 610 can represent a percentage of the minutes per week for the room in which the individual says in the room for more one minute or more. In the example implementation, if the individual says in the room for more one minute or more, a presumption can be made that the room is a destination for the individual. Other times besides one minute are possible. The pass-through percentage 608 and the destination percentage 610 for a room always add up to 100 percent.

Home recommendation engine 114 can use the data regarding the traffic patterns to create a traffic history for the home. For example, using time stamps and minutes spent in rooms, home recommendation engine 114 can determine that an individual moved from the family room through the kitchen to the dining room. As another example, home recommendation engine 114 can determine that an individual moved from the living room to the dining room. Home recommendation engine 114 can capture records of these and other traffic patterns in the home and can determine how each room is being used. Home recommendation engine 114 can analyze these and other traffic patterns in the home and can provide a recommendation for an optimal layout of rooms in the next home.

The traffic history 612 column of user interface screen 600 can display a history of movements to each destination room. For the example movements above regarding the dining room, the dining room 622 row of the traffic history 612 column can provide a listing of each of the two movements (from the family room, through the kitchen to the dining room and from the living room to the dining room). Other movements for a destination of the dining room 622 can be listed. In addition, other movements for other rooms that are destination locations can be listed in the respective rows of the traffic history 622 column. List pointers 614 can be used for each row of traffic history column 622 to display the respective histories. When each respective list pointer 614 is selected, a list box with a scroll bar can be displayed showing the traffic history for each selected room.

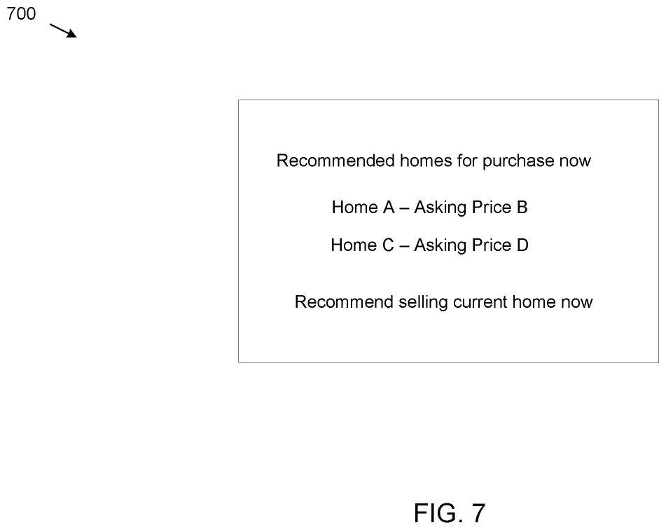

FIG. 7 shows an example user interface screen 700 that can display a recommendation regarding one or more of selling the current home and purchasing the next home. The recommendation can be made by home recommendation module 212, as discussed earlier herein. FIG. 7 shows an example recommendation to the home owner of two homes recommended for purchase and a recommendation to sell the current home now. The home owner can decide to explore one or more of the recommended homes and decide whether to purchase one of the homes based on the recommendation.

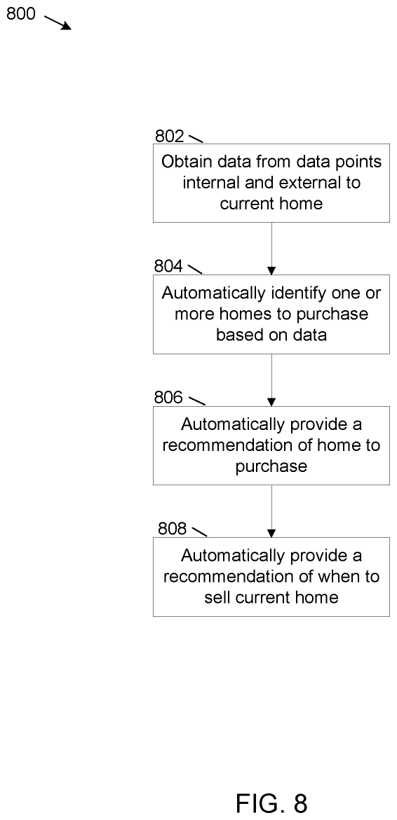

FIG. 8 shows a flowchart for an example method 800 for automatically recommending a home for purchase. The recommendation can be based on data from internal data points in the home and data points external to the home. The recommendation can also include when to sell a current home.

At operation 802, data is obtained from data points internal and external to the current home. Internal data points can include personal information regarding the home owner and the home owner's family, preference data regarding what is wanted in a next home, data regarding traffic patterns in the current home and data regarding a status and condition of appliances and home systems such as heating and air conditioning. External data points can include a commuting history of individuals who have full-time jobs in the home owner's family, data regarding such items as schools, parks, shopping, noise and crime in proposed areas for the next home and current market conditions for new homes, sale of existing homes and mortgage interest rates. Other or different internal and external data is possible.

At operation 804, one or more homes for purchase are automatically identified based on the data of operation 802. Home search module 208 can use the data to identify characteristics of a home that would be desirable and acceptable to the home owner. Home search module 208 can also initiate a search for new home based on the identified characteristics. In some implementations, as discussed earlier herein, one or more third-party sources can be used to perform the home search.

At operation 806, home recommendation module 212 can automatically provide a recommendation of identified homes to purchase. Home recommendation module 212 can also include asking prices for the identified homes. In addition, home recommendation module 212 can provide a recommendation of a best time to sell the current home. If a recommendation includes purchasing a specific home now, home recommendation module 212 can also indicate whether it would be acceptable to sell the current home now.

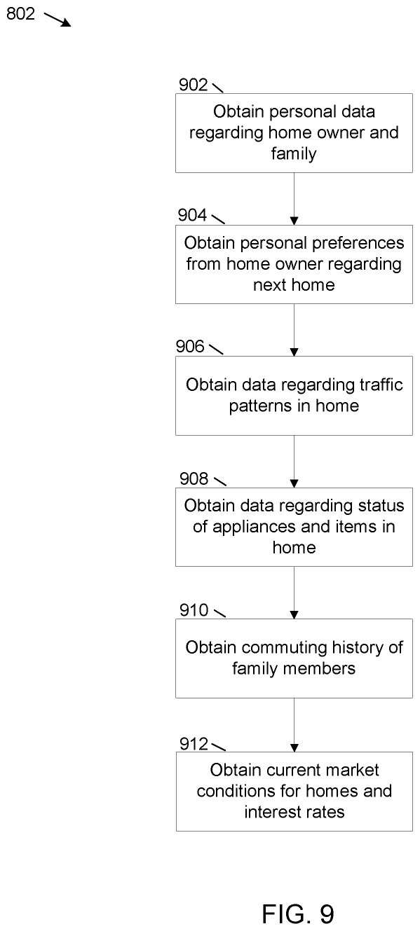

FIG. 9 shows a flowchart for operation 802 of FIG. 8 for obtaining data from data points internal and external to the current home.

At operation 902, personal data is obtained regarding the home owner and the home owner's family. The personal data can include such information as name, address, contact information, age, current employer, current salary and other personal information for the home owner and family members of the home owner. Other personal information can be provided. The personal information can be provided in one or more ways including filling out forms, personal contact with an employee of the organization, telephone contact and over the Internet.

At operation 904, personal preferences from the home owner regarding the next home are obtained. The personal preferences can be entered in a user interface on a digital dashboard for the home recommendation engine, similar to user interface screen 400 of FIG. 4. The personal preferences can include preferences regarding a type of home, number of bedrooms, type of rooms, preferred commute time, preferred age of home, preferred price range and preferred time frame to move. Other preferences can include the importance to the home owner and the home owner's family of certain attributes such as schools, parks and shopping.

At operation 906, data is obtained regarding traffic patterns of individuals in the current home. The traffic patterns can be obtained using motion sensors and cameras in the rooms of the current home.

At operation 908, data is obtained regarding a status and condition of appliances and items in the current home. The data can be obtained via sensor devices that are attached or embedded to the appliances and items and by data that can be manually provided by the home owner. Status and condition data can be obtained from items such as the roof, siding, furnace, air conditioner, humidifier and other items of the current home.

At operation 910, a commuting history of commutes from the current home to a place of employment can be provided for the home owner and members of the home owner's family who have a full-time job. As discussed, the commuting history can be obtained using GPS software than can be included on a software application of a smartphone or included in a vehicle used for commuting.

At operation 912, information is obtained regarding current market conditions for home and current interest rates. This information can include such items as a number of homes currently available for sale in a geographical area, an average number of days to sell the homes, a range of sales prices for homes sold and other items.

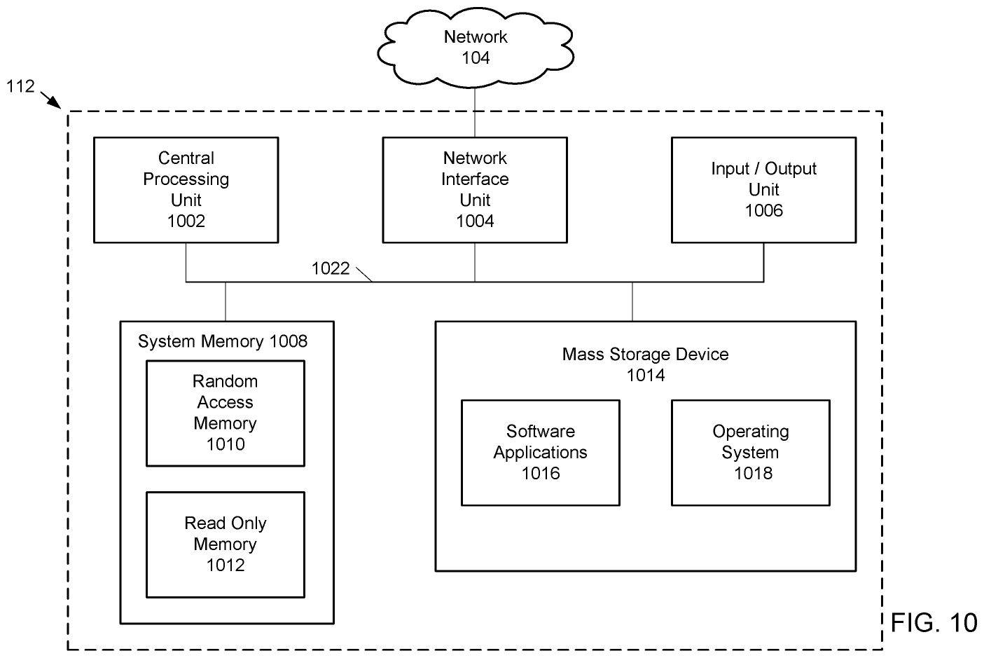

As illustrated in the example of FIG. 10, organization server computing device 112 includes at least one central processing unit (“CPU”) 1002, also referred to as a processor, a system memory 1008, and a system bus 1022 that couples the system memory 1008 to the CPU 1002. The system memory 1008 includes a random access memory (“RAM”) 1010 and a read-only memory (“ROM”) 1012. A basic input/output system that contains the basic routines that help to transfer information between elements within the organization server computing device 112, such as during startup, is stored in the ROM 1012. The organization server computing device 112 further includes a mass storage device 1014. The mass storage device 1014 is able to store software instructions and data. Some or all of the components of the organization server computing device 112 can also be included in customer electronic computing device 102 and the other computing devices described herein.

The mass storage device 1014 is connected to the CPU 1002 through a mass storage controller (not shown) connected to the system bus 1022. The mass storage device 1014 and its associated computer-readable data storage media provide non-volatile, non-transitory storage for the organization server computing device 112. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the organization server computing device 112.

According to various embodiments of the invention, the organization server computing device 112 may operate in a networked environment using logical connections to remote network devices through the network 104, such as a wireless network, the Internet, or another type of network. The organization server computing device 112 may connect to the network 1020 through a network interface unit 1004 connected to the system bus 1022. It should be appreciated that the network interface unit 1004 may also be utilized to connect to other types of networks and remote computing systems. The organization server computing device 112 also includes an input/output controller 1006 for receiving and processing input from a number of other devices, including a touch user interface display screen, or another type of input device. Similarly, the input/output controller 1006 may provide output to a touch user interface display screen or other type of output device.

As mentioned briefly above, the mass storage device 1014 and the RAM 1010 of the organization server computing device 112 can store software instructions and data. The software instructions include an operating system 1018 suitable for controlling the operation of the organization server computing device 112. The mass storage device 1014 and/or the RAM 1010 also store software instructions and software applications 1016, that when executed by the CPU 1002, cause the organization server computing device 112 to provide the functionality of the organization server computing device 112 discussed in this document. For example, the mass storage device 1014 and/or the RAM 1010 can store software instructions that, when executed by the CPU 1002, cause the organization server computing device 112 to display received data on the display screen of the organization server computing device 112.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an electronic computing device for selecting a next home for purchase, the method comprising:
obtaining data from a plurality of sensor devices in a current home and from a plurality of data points external to the current home;
using the data from the sensor devices and the data points external to the current home, automatically selecting one or more aspects for the next home, including:
receiving traffic data of a homeowner from one or more of the sensor devices in the current home;
using the traffic data to identify which rooms in the current home are overutilized rooms and underutilized rooms by the homeowner of the current home;
identifying a floor plan layout using the overutilized rooms and the underutilized rooms; and
selecting at least one of the one or more aspects for the next home using the floor plan layout, including selecting the floor plan layout with a room that is identified as being one of the overutilized rooms, the room being greater in size than a corresponding room in the current home;
automatically identifying one or more next homes to purchase that include the at least one of the one or more of the aspects; and
automatically recommending one of the identified one or more next homes to purchase.

2-5. (canceled)

6. The method of claim 1, wherein the data points external to the current home include commuting data for occupants of the current home.

7. (canceled)

8. The method of claim 1, further comprising one or more of automatically determining a current interest rate for home mortgages, automatically identifying current prices of homes for sale and automatically obtaining information regarding an average number of days for selling homes similar to the current home of the user.

9-11. (canceled)

12. The method of claim 1, further comprising automatically recommending a location for the next home.

13-14. (canceled)

15. The method of claim 1, further comprising:
identifying a driving distance to work for the user and of one or more family members of the user; and
using the driving distance to identify the next home for purchase.

16-20. (canceled)
